(19) United States
(12) Patent Application Publication
(10) Pub. No.: US 2021/0152783 A1
(43) Pub. Date: May 20, 2021

(54) USE OF SLOW MOTION VIDEO CAPTURE BASED ON IDENTIFICATION OF ONE OR MORE CONDITIONS

(71) Applicant: Lenovo (Singapore) Pte. Ltd., Singapore (SG)

(72) Inventors: Nathan J. Peterson, Oxford, NC (US); Russell Speight VanBlon, Raleigh, NC (US); Joshua N. Novak, Wake Forest, NC (US); John Carl Mese, Cary, NC (US)

(21) Appl. No.: 16/688,768

(22) Filed: Nov. 19, 2019

(51) Int. Cl. H04N 7/18; G06K 9/00; G08B 13/196; H04N 5/232

(52) U.S. Cl. CPC H04N 7/181; G06K 9/00771; G08B 13/19645; H04N 7/185; G08B 13/19656; G08B 13/19682; H04N 7/188; H04N 5/23222

(57) ABSTRACT

In one aspect, a device may include at least one processor, a camera accessible to the at least one processor, and storage accessible to the at least one processor. The storage may include instructions executable by the at least one processor to identify a condition as existing for use of a slow motion setting. The slow motion setting may be used to generate video at the first device using the camera. The instructions may also be executable to, responsive to identification of the condition as existing, use the slow motion setting to generate video at the first device using the camera.

### FIELD

The present application relates to technically inventive, non-routine solutions that are necessarily rooted in computer technology and that produce concrete technical improvements.

### BACKGROUND

Slow motion video capabilities are provided on many modern consumer electronics devices that have cameras, such as many modern smart phones. However, as recognized herein, slow motion video often captures so much video for a given recording that it takes up an undesirable amount of storage space because of the amount of image frames typically captured during the slow motion recording. But as also recognized herein, there might be times when a user might still wish to capture slow motion video notwithstanding these storage constraints. There are currently no adequate solutions to the foregoing computer-related, technological problem.

### SUMMARY

Accordingly, in one aspect a first device includes at least one processor, a camera accessible to the at least one processor, and storage accessible to the at least one processor. The storage includes instructions executable by the at least one processor to identify a condition as existing for use of a slow motion setting. The slow motion setting is used to generate video at the first device using the camera. The instructions are also executable to, responsive to identification of the condition as existing, use the slow motion setting to generate video at the first device using the camera.

The condition may include something other than receiving touch input to a touch-enabled display of the first device to invoke the slow motion setting rather than using a default video capture setting. For example, the first device may include at least one motion sensor and the condition may be identified at least in part based on input from the motion sensor. In certain examples, the at least one motion sensor may include an accelerometer and the condition may be identified based at least in part on input from the accelerometer indicating motion above a threshold amount.

As another example, the condition may be identified based at least in part on input from the camera indicating motion above a threshold amount. Additionally or alternatively, the condition may be identified based at least in part on identification of a predetermined activity as being performed by a person shown in at least one image from the camera. The condition may also be identified based at least in part on identification of a predetermined object being shown in at least one image from the camera. Still further, the condition may be identified based at least in part on input from the camera indicating a location that is associated with invoking the slow motion setting.

Providing yet another example, the first device may include a global positioning system (GPS) transceiver and the condition may be identified based at least in part on coordinates from the GPS transceiver indicating a current location of the first device that is associated with invoking the slow motion setting.

Still further, in some implementations the instructions are executable by the at least one processor to receive input from a second device different from the first device, where the second device may be a wearable device. In these implementations, the instructions may then be executable to identify the condition as existing for use of the slow motion setting based on the input from the second device. The input from the second device may indicate motion above a threshold amount.

Also in some implementations, the instructions may be executable to identify the condition as existing for use of the slow motion setting based at least in part on crowdsourced data accessible to the first device.

The slow motion setting may be used to gather image frames at a faster rate than a default setting to generate video at the first device using the camera.

In another aspect, a method includes identifying a condition as existing for use of a slow motion feature at a device comprising a camera. The slow motion feature is used to generate video at the device using the camera. The method also includes, responsive to identifying the condition as existing, using the slow motion feature to generate video at the device using the camera.

In some implementations, the condition may include something other than a user providing a command to invoke the slow motion feature rather than use of a default video capture feature. Additionally, the device may gather images at a rate of at least one hundred twenty frames per second according to the slow motion feature.

In some examples, the condition may include identification of an activity and/or an object associated with use of the slow motion feature being indicated in input from the camera.

In another aspect, at least one computer readable storage medium (CRSM) that is not a transitory signal includes instructions executable by at least one processor to identify a condition as existing for gathering slow motion video using a camera accessible to the at least one processor. The gathering of slow motion video includes gathering images at a rate of one hundred twenty frames per second or more, and the condition is something other than receipt of user input to a touch-enabled display to invoke a slow motion video setting rather than using a default video capture setting. The instructions are also executable to gather and store slow motion video using the camera responsive to identification of the condition as existing.

As examples, the condition may include one or more of existence of an object that is associated with use of slow motion video as indicated within a current field of view of the camera, existence of an activity as currently ongoing that is associated with use of slow motion video as indicated within the current field of view of the camera, and/or identification of a location that is associated with use of slow motion video as indicated within the current field of view of the camera.

Additionally, in some implementations the instructions may be executable to gather additional video using the default video capture setting prior to and after gathering the slow motion video, store the additional video in a single file with the slow motion video, and edit the single file to include the slow motion video but not the additional video gathered using the default video capture setting.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIG. 3 shows a live feed of a camera that may be used for identifying whether one or more conditions exist for slow motion video recording consistent with present principles;

FIGS. 4 and 5 show flow charts of example algorithms consistent with present principles; and

FIG. 6 shows an example graphical user interface (GUI) for configuring one or more settings of a device consistent with present principles.

### DETAILED DESCRIPTION

Among other things, the present application discloses devices that may identify portions of video showing a high amount of movement or action and automatically tag those sections for slow motion video recording. For example, if a person is already recording video of a gymnastics competition, the device may turn on slow motion video recording responsive to identification of a gymnast starting his or her routine.

In some examples, the device may then only keep the extra frames of slow motion video for video that has motion in it at all, and otherwise may only store the video according to a default recording rate since, e.g., watching a mature tree grow in slow motion looks the same as a growing tree in normal motion. Also in some examples, the device may only keep the extra frames of slow motion video for scenes with certain objects (e.g., certain animals or even certain particular people recognized by the device using facial recognition).

Additionally, in some implementations the device may factor in its own movement as indicated via accelerometer input to, for example, identify action to record. This might occur if the person's hand moves as her or she is filming others, indicating that slow motion might be useful.

The device may also factor in locations where people would typically move a lot and hence where slow motion might be useful. Those locations might include, as examples, tennis courts, gymnasiums, baseball fields, soccer fields, performing arts centers, etc. Still further, the device may also factor in wearable device activity of the video subject, such as if the subject is doing an activity that might include movement that might be desirable to capture in slow motion video.

Crowdsourcing of specific objects, locations, activities, etc. for the device to look for in order to trigger slow motion video recording may also be used. For example, the device may parse data from other devices to determine locations where slow-motion is typically used and use that crowdsourced data to perform slow motion video recording under similar circumstances.

Prior to delving further into the details of the instant techniques, it is to be understood with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino Calif., Google Inc. of Mountain View, Calif., or Microsoft Corp. of Redmond, Wash. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any general purpose single- or multi-chip processor that can execute logic by means of various lines such as address lines, data lines, and control lines and registers and shift registers. Moreover, any logical blocks, modules, and circuits described herein can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, CD ROM or Flash drive). The software code instructions may also be downloaded over the Internet. Accordingly, it is to be understood that although a software application for undertaking present principles may be vended with a device such as the system 100 described below, such an application may also be downloaded from a server to a device over a network such as the Internet.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (that is not a transitory, propagating signal per se) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

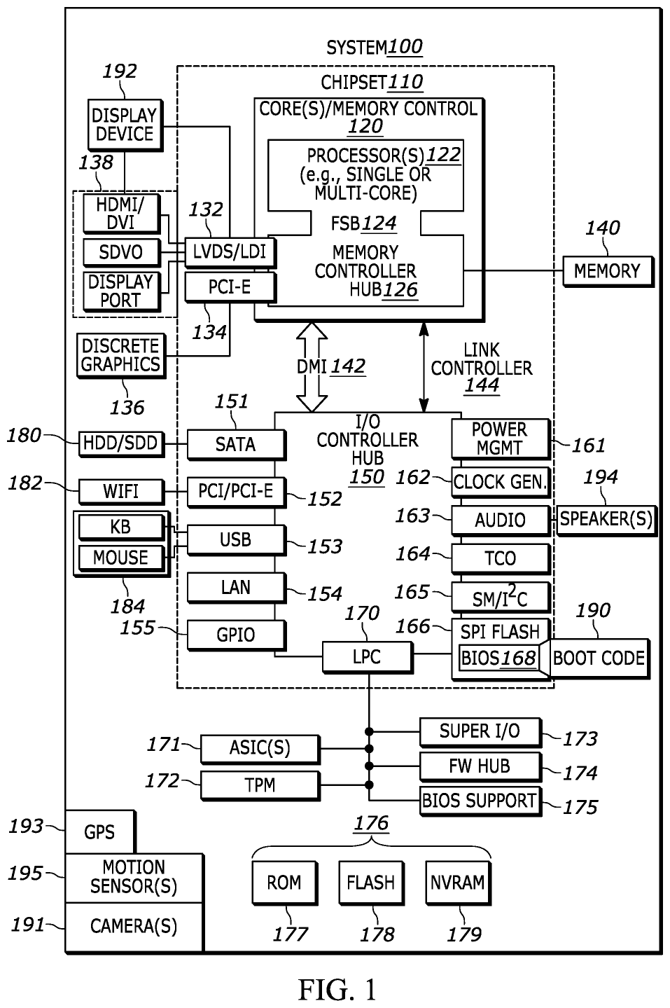

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (×16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

The system 100 may also include a camera(s) 191 that gathers one or more images and provides input related thereto to the processor 122. The camera 191 may be a thermal imaging camera, an infrared (IR) camera, a digital camera such as a webcam, a three-dimensional (3D) camera, and/or a camera otherwise integrated into the system 100 and controllable by the processor 122 to gather pictures/images and/or video. Also, the system 100 may include a GPS transceiver 193 that is configured to communicate with at least one satellite to receive/identify geographic position information and provide the geographic position information to the processor 122. However, it is to be understood that another suitable position receiver other than a GPS receiver may be used in accordance with present principles to determine the location of the system 100.

Still further, in addition to the camera 193, the system 100 may include other types of motion sensors as well. For instance, the system 100 may include other motions sensors 195 such as a gyroscope that senses and/or measures the orientation of the system 100 and provides input related thereto to the processor 122, and/or an accelerometer that senses acceleration and/or movement of the system 100 and provides input related thereto to the processor 122.

Still further, though not shown for simplicity the system 100 may also include an audio receiver/microphone that provides input from the microphone to the processor 122 based on audio that is detected, such as via a user providing audible input to the microphone.

It is to be understood that an example client device or other machine/computer may include fewer or more features than shown on the system 100 of FIG. 1. In any case, it is to be understood at least based on the foregoing that the system 100 is configured to undertake present principles.

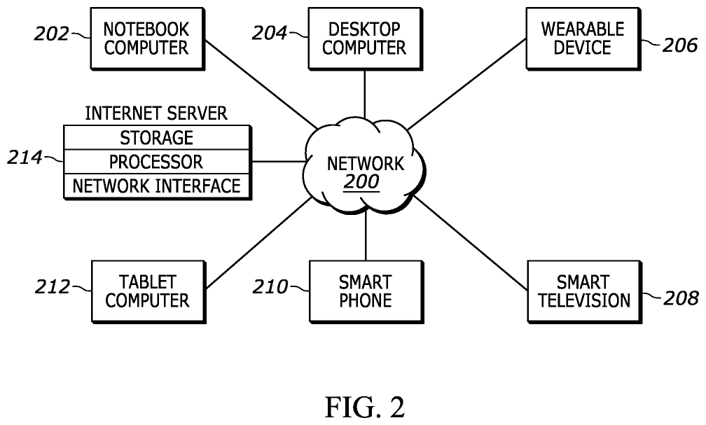

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 are configured to communicate with each other over the network 200 to undertake present principles.

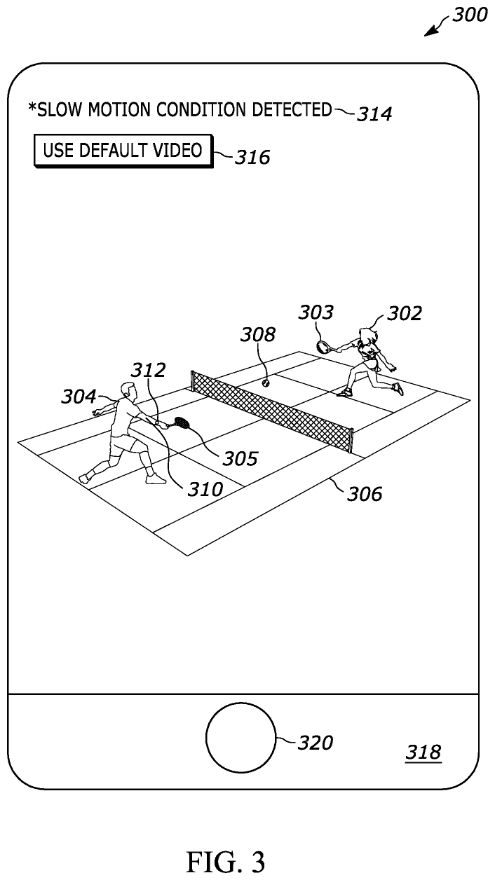

Now describing FIG. 3, it shows an example live feed 300 of real time images from a field of view (FOV) of a camera disposed on a smart phone or other end-user device consistent with present principles. The live feed 300 as shown in FIG. 3 may be presented on the smart phone's display as part of a viewfinder, for example, and may not show images actually stored to volatile (e.g., random access memory) or non-volatile memory.

As shown, a first person 302 and a second person 304 are playing tennis on a tennis court 306. Consistent with present principles, the smart phone may detect one or more different conditions indicated in the live feed 300 as existing to trigger slow motion video recording. For example, the smart phone may execute object recognition using images from the camera to recognize one of the tennis rackets 303, 305 being held by one of the people 302, 304 and access a relational database to determine that an entry for the database indicates that tennis rackets are objects for which the smart phone is to use a slow motion setting to record slow motion video. Other example objects that might be indicated in the relational database as being objects for which the smart phone is to use the slow motion setting may include baseball bats, motorcycles, dogs, etc.

As another example, the smart phone may execute object recognition using images from the camera to recognize the tennis court 306 and access a relational database to determine that an entry for the database indicates that tennis courts are locations for which the smart phone is to use the slow motion setting to record slow motion video. Other example locations that might be indicated in the relational database as being locations for which the smart phone is to use the slow motion setting may include baseball fields, performing arts centers, highways, etc.

Additionally, the smart phone may execute gesture recognition using images from the camera to recognize the people 302, 304 as playing tennis and then access a relational database to determine that an entry for the database indicates that playing tennis is an activity for which the smart phone is to use the slow motion setting to record slow motion video. Other example activities that might be indicated in the relational database as being activities for which the smart phone is to use the slow motion setting may include playing baseball, diving into a swimming pool, driving along a highway, etc.

Note that the relational databases disclosed above may have been initially configured by a system administrator. The databases may then be made accessible to the smart phone and other end-user devices via a publicly-accessible Internet server, and/or by providing them to the end user devices for storage at those respective devices.

As yet another example, the smart phone may execute computer vision and/or gesture recognition using images from the camera to recognize one or both of a tennis ball 308 or arm 310 of the person 304 as moving, or even accelerating, more than a threshold amount in three dimensional space (e.g., two meters per second for motion/velocity, one and a half meters per second squared for acceleration, etc.). Responsive to detecting velocity or acceleration above the threshold amount, the smart phone may determine that it is to use its slow motion setting to record slow motion video showing the recognized motion.

The smart phone may also detect one or more different conditions as existing other than those indicated in the live feed 300 to trigger slow motion video recording. For example, input from an accelerometer on the smart phone may be used by the smart phone to determine that the smart phone itself is undergoing motion, or even acceleration, more than a threshold amount (e.g., a quarter meter per second for motion/velocity, half a meter per second squared for acceleration). Similarly, input from an accelerometer on a wearable device such as a smart watch 312 worn by the person 304 while playing tennis may be wirelessly transmitted to the smart phone and used by the smart phone to determine that the wearable device is undergoing motion, or even acceleration, more than a threshold amount since that too may indicate a condition for which slow motion video recording should be used.

As another example, input from a GPS transceiver on the smart phone may be used by the smart phone to determine that the smart phone is currently located at a location or location type (e.g., tennis courts) associated in a relational database with use of slow motion video recording.

Crowdsourced data may also be used. The crowdsourced data may be stored at a remotely-located server and indicate that plural other end user devices have used slow motion video recording at least a threshold number of times (e.g., one hundred times) in the past under the same or similar conditions, such as at the same location as the current location of the smart phone as expressed in GPS coordinates or at a location within a threshold radius (e.g., five meters) of the smart phone's current location.

Crowdsourced data may also be used to determine that when a same or similar object (e.g., a tennis racket, or any type of sports racket in general) was recognized at least a threshold number of times in the past at other end user devices using their own camera input, slow motion video recording was invoked by other users. The smart phone may then itself also invoke slow motion video recording based on that. The same can be said for use of crowdsourced data to invoke slow motion video recording for certain activities (e.g., playing tennis) and certain locations (e.g., a tennis court) also recognized at other devices a threshold number of times in the past when slow motion video recording was invoked by other users.

Also note that in addition to or in lieu of using crowdsourced data and/or the relational databases disclosed above, an artificial intelligence model employing one or more recurrent or deep neural networks may also be used for identifying whether a certain condition exists to trigger slow motion video recording.

Regardless of which methods and conditions are used for determining whether a condition exists for which to use slow motion video recording, once the condition itself has been identified the smart phone may control its camera to begin recording slow motion video without receiving additional input from a user, such as without also receiving touch input to a touch-enabled display of the smart phone to invoke a slow motion setting to perform the slow motion video recording as opposed to using a default video capture setting. Then as the smart phone records the slow motion video, it may progressively store image frames of the video in volatile and/or non-volatile memory. The volatile memory may be random access memory (RAM), and the non-volatile memory may be a hard disk drive or solid state storage.

As also shown in FIG. 3, while the smart phone records the slow motion video, it may present a graphical indication 314 that includes both a star icon and text indicating “slow motion condition detected”. This may inform the user that a condition for slow motion video recording has been identified and/or that slow motion video recording is currently being performed automatically based on detection of the condition.

In some examples, the indication 314 may be accompanied by a selector 316. The selector 316 may be selectable to command the smart phone to use a default video recording frame rate for video recording of the players 302, 304 playing tennis, rather than using the frame rate for slow motion video recording. In some examples, selection of the selector 316 may even command the smart phone to upload data to a database of crowdsourced data to reduce a count total for the number of times end user devices used slow motion video recording for the identified type of activity, object, location, etc. so that future determinations may be made by other devices based on crowdsourced data and the updated count total consistent with present principles.

FIG. 3 also shows that below the live feed 300 as presented on the smart phone's display may be graphical user interface (GUI) 318. The GUI 318 may include a soft button 320 that may be selectable to initiate slow motion video recording in examples where the smart phone might not have autonomously began slow motion video recording itself responsive to identification of one or more of the conditions set forth above. The soft button 320 may therefore be automatically presented in place of a selector that would otherwise be presented for use of the default video recording frame rate responsive to the smart phone identifying one or more of the conditions set forth above.

As for slow motion video recording itself as might be performed based on use of a slow motion setting, it is to be understood that slow motion video recording may include use of an image/frame rate for video recording that is higher than the device uses by default to record video when a user does not provide input specifying that slow motion video recording should be used. Thus, slow motion video recording may include use a frame rate of at least one hundred twenty images per second and therefore be faster than the sixty frames per second rate beyond which some studies show that humans cannot perceive all images during real time video playback under certain viewing conditions. In some examples, slow motion video recording may even use a frame rate of two hundred forty frames per second, four hundred eighty to five hundred frames per second, or even “super slow mo” rates of nine hundred sixty to one thousand images per second and beyond.

Thus, in various example implementations slow motion video recording may entail use of a frame rate of at least one hundred twenty images per second so that the video recorded at that rate may be presented in slow motion using a 60 Hertz display refresh rate to thus play back the recorded video at a speed that is less than real time speed and/or that takes longer to play back at the 60 Hertz refresh rate than the actual amount of time it took to record the slow motion video itself.

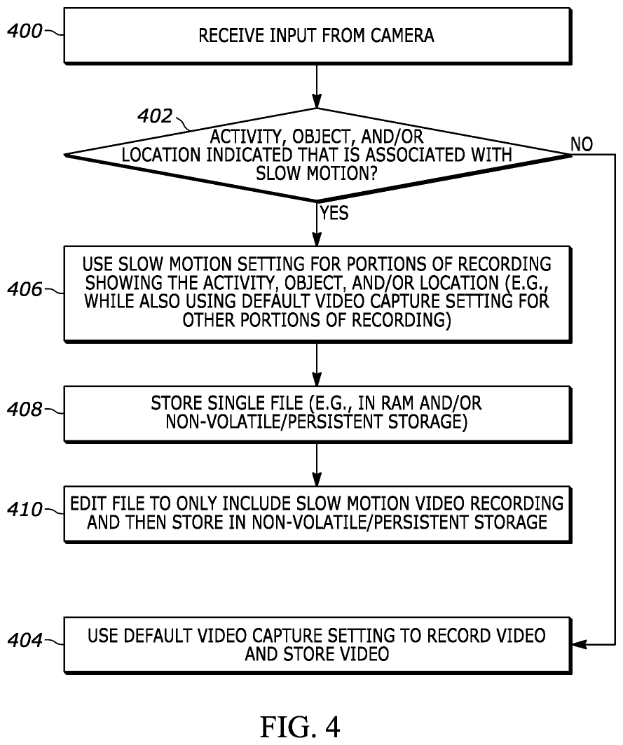

Referring now to FIG. 4, it shows example logic that may be executed by a device such as the system 100 and/or an end-user's device to perform slow motion video recording consistent with present principles. For example, the logic of FIG. 4 may be executed by the smart phone discussed above in relation to FIG. 3.

Beginning at block 400, the logic may receive camera input, such as a real time live feed of the current field of view of the device's digital camera. The logic may then proceed to decision diamond 402 where the device may determine whether a condition that is associated with slow motion video recording is indicated in the camera input. The condition may be a predetermined activity, object, or location already associated with use of slow motion video recording (e.g., in one of the relational databases discussed above). A negative determination may cause the logic to proceed to block 404 where the device may use a default video capture setting to record and store video at a default rate (e.g., sixty frames per second).

However, an affirmative determination at diamond 402 may instead cause the logic to proceed to block 406. At block 406 the device may use a slow motion setting for at least part of a single video recording so that, for example, a default rate of sixty frames per second may be used to record video that is not determined to show the condition (e.g., activity or object) and then the device may automatically switch to using the slow motion setting for recording additional portions of the same video that show the condition at the slow motion rate. Then at block 408 the device may store, as a single file locally at the device, video recorded using the slow motion rate as well as any video recorded at the default rate for times immediately preceding and following times during which slow motion video recording was used. The device may store the single file in volatile storage (e.g., RAM) and/or at a single file path persistent storage location in non-volatile persistent storage (e.g., a hard disk drive or solid state storage).

However, note that in other embodiments at block 406 the device may simply record slow motion video showing the identified conditions and store it as a single file as set forth above without also storing any additional video as part of the single file that was recorded using the default rate.

From block 408 the logic may then move to block 410. At block 410 and assuming the example above where both slow motion video and non-slow motion video are stored as a single file, the device may then automatically edit the file to delete non-slow motion frames/portions and only include the slow motion video frames/portions. Also at block 410, the device may then store the edited video with only slow-motion video in non-volatile storage.

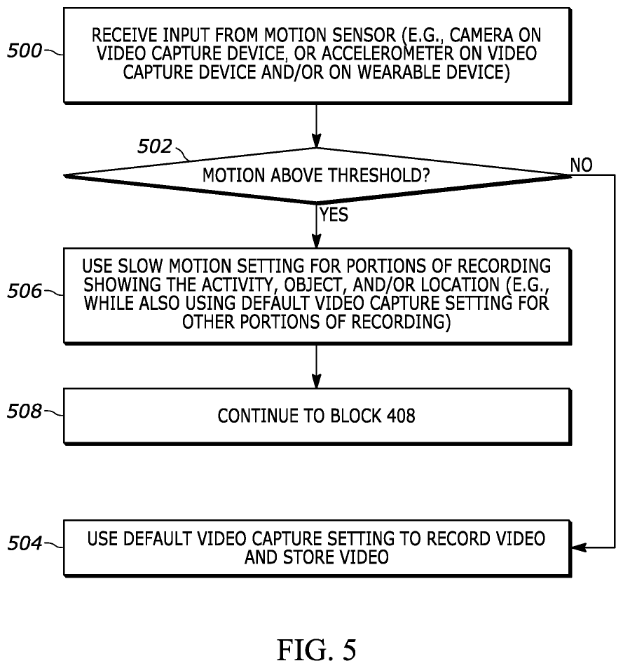

Now in reference to FIG. 5, it shows example logic that may also be executed by an end-user's device consistent with present principles. For example, the logic of FIG. 5 may be executed in conjunction with the logic of FIG. 4 by the same device.

Beginning at block 500, the device may receive input from a motion sensor on the device or a motion sensor on another device, such as another person's smart watch according to the example described above in reference to FIG. 3. The motion sensor itself may be an accelerometer in some examples, though it may also be a camera, gyroscope, etc. From block 500 the logic may then proceed to decision diamond 502.

At diamond 502 the device may determine whether the input from the motion sensor indicates motion above a threshold amount. For example, if the input is from an accelerometer on the device undertaking the logic of FIG. 5 or on another device, the decision at diamond 502 may be whether the accelerometer input indicates motion of the device above a threshold amount. If the input is from a camera on the device undertaking the logic of FIG. 5, the decision at diamond 502 may be whether the camera input indicates motion of an object in the camera's field of view above a threshold amount. Note that the motion and motion threshold themselves may relate to velocity or acceleration, as discussed above.

A negative determination at diamond 502 may cause the logic to proceed to block 504. At block 504 the device may use a default video capture setting to record and store video at a default rate (e.g., sixty frames per second). However, an affirmative determination at diamond 502 may instead cause the logic to proceed to block 506. At block 506 the device may use a slow motion setting for at least part of a single video recording so that, for example, a default rate of sixty frames per second may be used to record video that is not determined to show the condition (e.g., activity or object) and then the device may automatically switch to using the slow motion setting for recording additional portions of the video showing the condition at the slow motion rate. Then at block 508 the logic may continue to block 408 of FIG. 4 and undertake actions as described above before also proceeding to block 410 in some examples. However, note that in other embodiments at block 506 the device may simply record slow motion video based on the identified conditions and store it as a single file at block 408 of FIG. 4 without also storing any additional video as part of the single file that was recorded at the default rate.

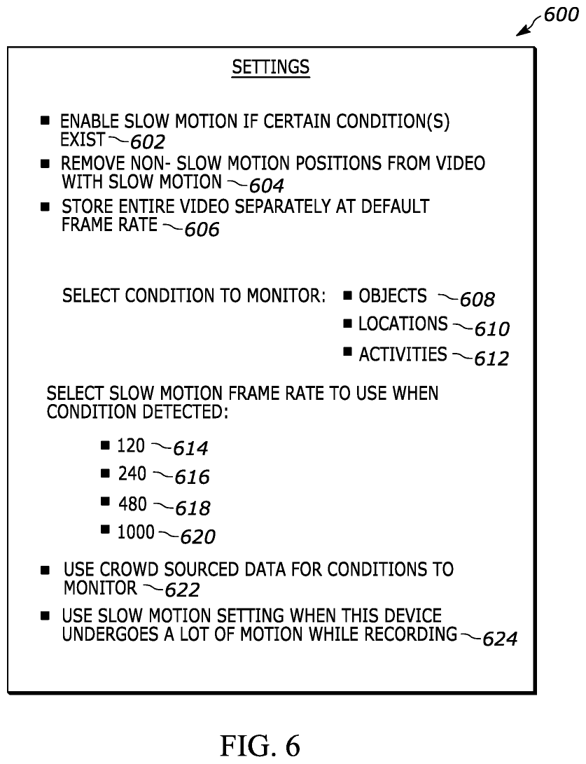

Now describing FIG. 6, it shows an example graphical user interface (GUI) 600 that is presentable on the display of an end-user's device for configuring one or more settings of the device related to slow motion video capture consistent with present principles. For example, the GUI 600 may be presented on the display of the smart phone described above in reference to FIG. 3 and/or the display of a device undertaking the logic of FIGS. 4 and/or 5. Note that each of the options to be discussed below may be selected by selecting the respective check box adjacent to the option via touch input, cursor input, etc.

As shown, the GUI 600 may include a first option 602 that may be selectable to configure the device to enable autonomous slow motion video capture/recording responsive to the device identifying one or more conditions consistent with present principles. For example, selection of the option 602 may set or configure the device to undertake the functions described above in reference to the smart phone of FIG. 3 and/or to execute the logic of FIGS. 4 and 5.

The GUI 600 may also include an option 604 that may be selected to set or configure the device to autonomously remove non-slow motion portions of a single video recording consistent with present principles. For example, selection of the option 604 may configure the device to specifically undertake the actions described above in reference to blocks 406 and 506.

As also shown in FIG. 6, the GUI 600 may include an option 606 that may be selectable to set or configure the device to not just remove non-slow motion portions from a single video recording consistent with present principles but to also separately store an entire recording having both slow motion segments and non-slow motion segments as a separate file, but only at the device's default video recording/frame rate. For example, to create this separate file of slow motion and non-slow motion segments, the device may remove half of the images from slow-motion portions recorded at one hundred twenty frames per second (e.g., one out of every two consecutive images) and then store the remaining images as a single file with surrounding video portions that were recorded at only sixty frames per second.

FIG. 6 also shows that the GUI 600 may include options 608, 610, and 612 for selection of various particular conditions that the device is to monitor for generating slow motion video consistent with present principles. Thus, option 608 may be selected to enable monitoring for the presence of certain predetermined objects within the camera's field of view, option 610 may be selected to enable monitoring for the presence of certain predetermined locations within the camera's field of view, and option 612 may be selected to enable monitoring for the performance of certain predetermined activities within the camera's field of view. Note that options may also be presented for any of the other conditions disclosed herein and that only three are being shown in FIG. 6 for simplicity.

Additionally, in some examples the GUI 600 may include one or more options 614, 616, 618, and 620 to select a particular slow motion recording/frame rate to use upon identification of one of the conditions disclosed herein. Thus, option 614 may be selected to set the device to use a recording rate of one hundred twenty frames per second, option 616 may be selected to set the device to use a recording rate of two hundred forty frames per second, option 618 may be selected to set the device to use a recording rate of four hundred eighty frames per second, and option 620 may be selected to set the device to use a recording rate of one thousand frames per second.

The GUI 600 may also include an option 622 that may be selected to set the device to use crowdsourced data for identifying conditions for which slow motion video recording should be used consistent with present principles. An option 624 may also be selected to perform slow motion video recording responsive to the device detecting motion above a threshold amount consistent with present principles. For example, even if the device might already be currently recording video using a default recording rate, upon the device detecting motion above a threshold amount the device may then automatically switch to using its slow motion video recording rate for a subsequent portion of the same video recording until motion is detected as going back below the threshold amount (or until a threshold time passes from when the device initially underwent motion of at least the threshold amount).

It may now be appreciated that present principles provide for an improved computer-based user interface that improves the functionality, available storage capacity, and ease of use of the devices disclosed herein. The disclosed concepts are rooted in computer technology for computers to carry out their functions.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

1. A first device, comprising:
at least one processor;
a camera accessible to the at least one processor; and
storage accessible to the at least one processor and comprising instructions executable by the at least one processor to:
identify a condition as existing for use of a slow motion setting, the slow motion setting being used to generate video at the first device using the camera;
responsive to identification of the condition as existing, use the slow motion setting to generate video at the first device using the camera;
wherein the instructions are executable by the at least one processor to:
identify the condition as existing for use of the slow motion setting based at least in part on crowdsourced data accessible to the first device.

2. (canceled)

3. The first device of claim 1, comprising at least one motion sensor, and wherein the condition is identified at least in part based on input from the motion sensor.

4. The first device of claim 3, wherein the at least one motion sensor comprises an accelerometer, and wherein the condition is identified based at least in part on input from the accelerometer indicating motion above a threshold acceleration amount.

5. The first device of claim 1, wherein the condition is identified based at least in part on input from the camera indicating motion above a threshold velocity amount.

6. The first device of claim 1, wherein the condition is identified based at least in part on execution of gesture recognition to identify a predetermined activity as being performed by a person shown in at least one image from the camera.

7. The first device of claim 1, wherein the condition is identified based at least in part on execution of object recognition to identify a predetermined object being shown in at least one image from the camera.

8. The first device of claim 1, comprising a global positioning system (GPS) transceiver, and wherein the condition is identified based at least in part on coordinates from the GPS transceiver indicating a current location of the first device that is associated in a relational database with invoking the slow motion setting.

9. The first device of claim 1, wherein the condition is identified based at least in part on input from the camera indicating a location that is associated in a relational database with invoking the slow motion setting.

10. The first device of claim 1, wherein the instructions are executable by the at least one processor to:
receive input from a second device different from the first device, the second device being a wearable device; and
based on the input from the second device, identify the condition as existing for use of the slow motion setting, the condition comprising acceleration of the wearable device above a threshold acceleration amount.

11. The first device of claim 10, wherein the input from the second device indicates motion above a threshold velocity.

12. (canceled)

13. The first device of claim 1, wherein the slow motion setting is used to gather image frames at a faster rate than a default setting to generate video at the first device using the camera.

14. A method, comprising:
generating first video using a camera and a default video capture feature;
identifying a condition as existing for use of a slow motion feature at a device comprising the camera, the slow motion feature being used to generate second video at the device using the camera;
responsive to identifying the condition as existing, using the slow motion feature to generate the second video at the device using the camera;
storing the first video and the second video in a single file; and
editing the single file to include the second video generated using the slow motion feature but not the first video generated using the default video capture feature.

15. The method of claim 14, wherein the condition comprises something other than a user providing a command to invoke the slow motion feature rather than use of the default video capture feature, and wherein the device gathers images at a rate of at least one hundred twenty frames per second according to the slow motion feature.

16. The method of claim 15, wherein the condition comprises identification, using gesture recognition, of an activity associated with use of the slow motion feature being indicated in input from the camera.

17. The method of claim 15, wherein the condition comprises identification, using object recognition, of an object associated with use of the slow motion feature being indicated in input from the camera.

18. At least one computer readable storage medium (CRSM) that is not a transitory signal, the computer readable storage medium comprising instructions executable by at least one processor to:
identify a condition as existing for gathering slow motion video using a camera accessible to the at least one processor, the gathering of slow motion video comprising gathering images at a rate of one hundred twenty frames per second or more, the condition being something other than receipt of user input to a touch-enabled display to invoke a slow motion video setting rather than using a default video capture setting;
responsive to identification of the condition as existing, gather and store slow motion video using the camera;
wherein the instructions are executable by the at least one processor to:
prior to and after gathering the slow motion video, gather additional video using the default video capture setting;
store the additional video in a single file with the slow motion video; and
edit the single file to include the slow motion video but not the additional video gathered using the default video capture setting.

19. The CRSM of claim 18, wherein the condition comprises one or more of: existence of an object that is associated with use of slow motion video as indicated within a current field of view of the camera, existence of an activity as currently ongoing that is associated with use of slow motion video as indicated within the current field of view of the camera, identification of a location that is associated with use of slow motion video as indicated within the current field of view of the camera.

20. (canceled)

21. The method of claim 14, comprising:
presenting a settings graphical user interface (GUI) on a display, the settings GUI comprising an option selectable to set the device to edit files that include both slow motion video and default video to instead only include slow motion video; and
performing the editing of the single file to include the second video but not the first video based on the option already being selected.

22. The method of claim 14, wherein during the editing the first video is deleted from the single file.

23. The CRSM of claim 18, wherein during the editing the additional video is deleted from the single file.
